(19) United States
(12) Patent Application Publication
(10) Pub. No.: US 2002/0140950 A1
(43) Pub. Date: Oct. 3, 2002

(54) Image outputting apparatus, an image outputting method and a computer program thereof, and a computer-readable storage medium storing the program

(76) Inventors: Yasutoshi Ohta, Tokyo (JP); Hiroshi Ishii, Kanagawa (JP); Hiromi Okubo, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/105,361

(22) Filed: Mar. 26, 2002

(30) Foreign Application Priority Data
Mar. 28, 2001 (JP) 2001-094426

(51) Int. Cl. B41J 1/00; G06F 15/00

(52) U.S. Cl. 358/1.2; 358/1.15

(57) ABSTRACT

An image outputting apparatus includes a first information processing unit that performs a first information processing and a second information processing unit that performs a second information processing, where the second information processing unit is attachable to and detachable from the first information processing unit, and a detection unit that detects an operational status of the second information processing unit such that an image is output in predetermined resolution, based on the operational status of the second information processing unit, thereby an upgrading to a high speed processing system is attained with a higher overall throughput, a better performance-to-cost ratio and a lower initial cost.

### BACKGROUND OF THE INVENTION

1. Field of the Invention

The present invention generally relates to an image outputting apparatus, an image outputting method, an image outputting program, and a computer-readable storage medium that stores the computer program, and specifically relates to the image outputting apparatus, wherein first information processing and second information processing are provided such that a desired image quality in predetermined resolution is output, based on a checking result of status of the second information processing by the first information processing, the image outputting method thereof, the image outputting program thereof, and the computer-readable storage medium thereof.

2. Description of the Related Art

In recent years, output resolution required of a printer has been increasing. While higher resolution provides higher image quality, the amount of information to be processed for a high-resolution image is greatly increased. For this reason, if higher resolution is realized in a conventional architecture, a substantial reduction in output speed is inevitable. That is, although a catalog specification of the resolution may be high, printing speed becomes unbearably slow if the printer is based on a conventional architecture.

To attain a higher speed, a CPU with a higher performance (such as a higher driving clock frequency) is sometimes employed. However, a higher cost of the higher-speed CPU directly impacts the printer cost. Then, JP5-254184 (printer equipment), for example, proposes to use a sub processor such that both improvement in processing speed and curtailment of the costs are achieved, by distributing the processing load between the CPU and the sub processor.

Even in this equipment, however, a rise in the cost is inevitable. It should be further considered that print engines have advanced remarkably recently in terms of speed and quality. Further, users are diversified, and some users would accept a longer printing time for better printing quality, rather than paying additionally for faster printing.

Installing a sub processor improves the printing speed in general purpose printers, however, high-speed printers are not greatly helped, due to the speed of the sub processor being lower than the speed of the print engine, possibly causing a reduction in the performance-to-cost ratio.

Furthermore, in the case of printers that are connected to a network and have two or more data input interfaces, the amount of data to be processed in a unit time increases excessively when the data input interfaces operate in parallel, causing throughput to be significantly reduced.

### SUMMARY OF THE INVENTION

It is a general object of the present invention to offer a solution to the problem described above by providing an image outputting apparatus, an image outputting method, a computer program of the image outputting method, and a computer-readable storing medium thereof, that substantially obviate one or more of the problems caused by the limitations and disadvantages of the related art.

Features and advantages of the present invention will be set forth in the description that follows, and in part will become apparent from the description and the accompanying drawings, or may be learned by practice of the invention according to the teachings provided in the description. Objects as well as other features and advantages of the present invention will be realized and attained by an image outputting apparatus, an image outputting method, a computer program of the image outputting method, and a computer-readable storing medium particularly pointed out in the specification in such full, clear, concise, and exact terms as to enable a person having ordinary skill in the art to practice the invention.

In order to solve the problem mentioned above and to attain the object, the image outputting apparatus of the present invention is capable of installing a first information processing unit, and a second information processing unit that is attachable to and detachable from the first information processing unit. An operational status of the second information processing unit is checked by a detection unit provided in the first information processing unit. When the second information processing unit is functioning normally, a higher processing speed is available, hence a higher resolution can be offered to a user. When the second information processing unit is not functioning correctly, a direction unit inhibits use of the second information processing unit, thereby only the processing speed offered by the first information processing unit is used.

The invention further provides a method, a computer program and a computer-readable storage medium that fully utilize the information outputting apparatus as configured as above.

As a whole, the present invention provides an upgrading to a higher-speed system with an improved overall throughput, an enhanced performance-to-cost ratio, and a lowered initial cost.

### BRIEF DESCRIPTION OF THE DRAWINGS

FIG. 1 is a block diagram of an image outputting system of the first embodiment of the present invention;

FIG. 2 is a block diagram describing a specific configuration of the first embodiment of the present invention, as applied to a printer;

FIG. 3 is a figure showing an example of a variation of the embodiment of the printer in FIG. 2;

FIG. 4 is a figure showing an example of a variation of the embodiment of the printer in FIG. 2;

FIG. 5 is a figure showing an example of a variation of the embodiment of the printer in FIG. 2;

FIG. 6 is a figure showing an example of a variation of the embodiment of the printer in FIG. 2;

FIG. 7 is a figure showing an example of a variation of the embodiment of the printer in FIG. 2;

FIG. 8 is a figure showing an example of a variation of the embodiment of the printer in FIG. 2;

FIG. 9 is a figure showing an example of a variation of the embodiment of the printer in FIG. 2;

FIG. 10 is a figure showing an example of a printer status display in FIG. 2;

FIG. 11 is a figure showing an example of a printer status display in FIG. 2;

FIG. 12 is the figure showing an example of a printer status display in FIG. 2;

FIG. 13 is a figure showing an example of a printer status display in FIG. 2;

FIG. 14 is a figure showing an example of a printer status display in FIG. 2;

FIG. 15 is a figure showing an example of a printer status display in FIG. 2;

FIG. 16 is a figure describing the operation when applying the image outputting system of the first embodiment of the present invention to a printer;

FIG. 17 is a figure describing the operation when applying the image outputting system of the first embodiment of the present invention to a printer;

FIG. 18 is a figure describing the operation when applying the image outputting system of the first embodiment of the present invention to a printer;

FIG. 19 is a block diagram of an image outputting system of the second embodiment of the present invention;

FIG. 20 is a block diagram describing a specific configuration of the second embodiment of the present invention;

FIG. 21 is a figure describing the operation when applying the image outputting system in the second embodiment of the present invention to a printer;

FIG. 22 is a figure describing the operation when applying the image outputting system in the second embodiment of the present invention to a printer;

FIG. 23 is a figure describing the operation when applying the image outputting system in the second embodiment of the present invention to a printer;

FIG. 24 is a flowchart describing the operation when applying the image outputting system in the second embodiment of the present invention to a printer;

FIG. 25 is a flowchart describing the operation when applying the image outputting system in the second embodiment of the present invention to a printer;

FIG. 26 is a flowchart describing the operation when applying the image outputting system of the second embodiment of the present invention to a printer;

FIG. 27 a block diagram of principal parts of the image outputting system of a first variation of the second embodiment of the present invention;

FIG. 28 is a flowchart describing the operation when applying the image outputting system of the first variation of the second embodiment of the present invention to a printer;

FIG. 29 is a block diagram describing a specific configuration of a second variation of the second embodiment of the present invention;

FIG. 30 is a block diagram showing a printer of a third variation of the second embodiment of the present invention;

FIG. 31 is a flowchart describing the operation when applying the image outputting system in the third variation of the second embodiment of the present invention to a printer;

FIG. 32 is a flowchart describing the operation when applying the image outputting system in the third variation of the second embodiment of the present invention to a printer;

FIG. 33 is a block diagram showing a printer of a fourth variation of the second embodiment of the present invention;

FIG. 34 is a figure describing the operation when applying the image outputting system of the fourth variation of the second embodiment of the present invention to a printer;

FIG. 35 is a flowchart describing the operation when applying the image outputting system of the fourth variation of the second embodiment of the present invention to a printer;

FIG. 36 is a flowchart describing the operation when applying the image outputting system of the fourth variation of the second embodiment of the present invention to a printer;

FIG. 37 is a flowchart describing the operation when applying the image outputting system of the fourth variation of the second embodiment of the present invention to a printer;

FIG. 38 is a block diagram showing a configuration when applying an image outputting system of a fifth variation of the second embodiment of the present invention to a printer;

FIG. 39 is a flowchart describing the operation when applying the image outputting system of the fifth variation of the second embodiment of the present invention to a printer; and

FIG. 40 is a flowchart describing the operation when applying the image outputting system of the fifth variation of the second embodiment of the present invention to a printer.

### DESCRIPTION OF THE PREFERRED EMBODIMENTS

In the following, embodiments of an image outputting apparatus, an image outputting method, a computer program of the image outputting method, and a computer-readable storing medium for storing the program of the present invention will be described with reference to the accompanying drawings.

To start with, an overview of a configuration of an image outputting system including an image outputting apparatus of a first embodiment of the present invention is described.

[Image Output Configuration of System]

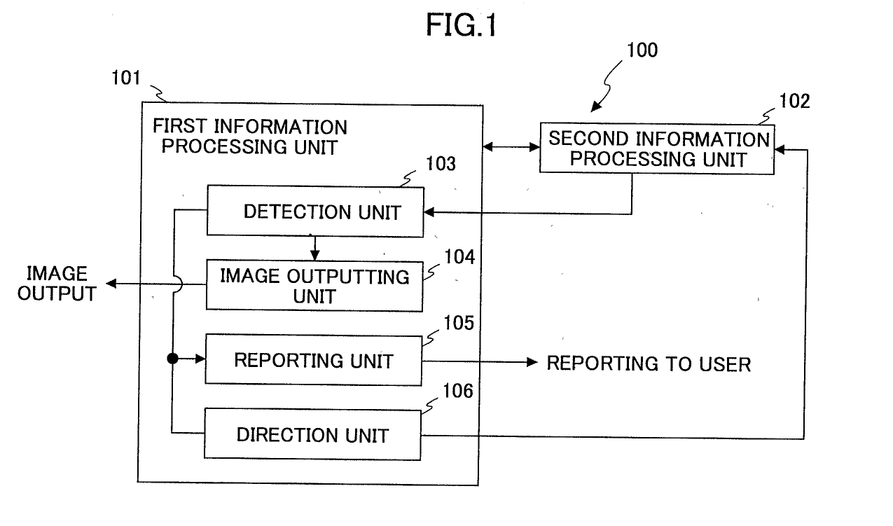

FIG. 1 is a block diagram of an image outputting system 100 of the first embodiment of the present invention. The image outputting system 100 includes a first information processing unit 101 that performs first processing, and a second information processing unit 102 that performs second processing, the latter processing unit 102 being detachable. The first information processing unit 101 checks operating status of the second information processing unit 102 by a detection unit 103. An image outputting unit 104 outputs an image at predetermined output resolution based on a checking result of the detection unit 103.

The first information processing unit 101 includes a reporting unit 105 that reports the checking result as to the operating status of the second information processing unit 102 to a user. Thereby, the first information processing can provide the user with the checking result of the operating status of the second information processing.

The first information processing unit 101 includes a directing unit 106 that causes the first information processing unit 101 to direct the second information processing unit 102 to operate, when the checking result indicates that the second information processing unit 102 is operating normally. Thereby, the first information processing can use the second information processing when the checking result of the operating status of the second information processing indicates that the second information processing performs a normal operation.

In the case that the second information processing unit 102 is engaged, the first information processing unit 101 outputs a user permission signal that allows a user to output in resolution higher than image output resolution of. the first information processing unit 101. Thereby, when the second information processing is used, the user can enjoy a resolution higher than the image output resolution of the first information processing.

In this manner, the image outputting system 100 can be upgraded to a system of a higher performance, offering a higher throughput, improved performance-to-cost ratio and reduction in initial cost.

[Composition of Printer]

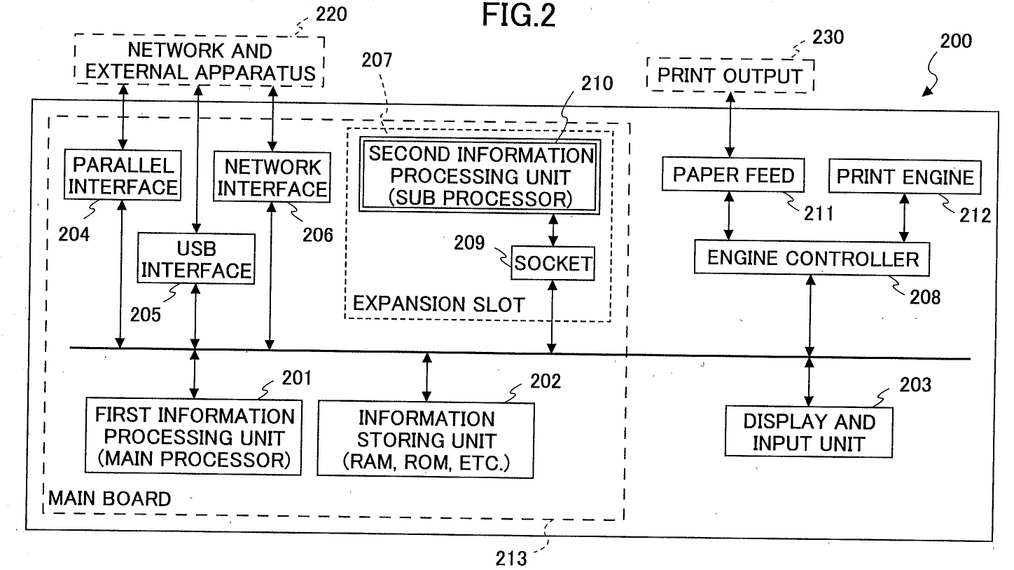

FIG. 2 is a block diagram showing a specific configuration of the first embodiment of the present invention. In FIG. 2, the image outputting system is applied to a printer. As shown in FIG. 2, a printer 200 includes a first information processing unit (main processor) 201, an information storage unit 202 that includes RAM, ROM, etc., a display and input unit 203, a parallel interface (parallel I/F) 204, a USB interface (USB I/F) 205, a network interface (network I/F) 206, an expansion slot 207, and an engine controller 208, all of which are connected to a bus line.

The network I/F 206 of the printer 200 performs communications processing. The first information processing unit 201 includes CPU etc., and controls information processing and an overall operation. The information storage unit 202 includes a ROM that stores various control programs required for a printing process, initial setting, and the like, a RAM as a working space, and the like.

The printer 200 further includes, a paper feed unit 211 and a print engine 212. The engine controller 208 controls the paper feed unit 211 and the print engine 212. The display and input unit 203 includes a display and control panel, and switches.

The expansion slot 207 includes a socket 209 connected to the bus line, and a second information processing unit (sub processor) 210 connected to the socket 209 that allows bi-directional communication. The bus line of the printer 200 is connected to a main board 213 that includes the first information processing unit 201, the information storage unit 202, the parallel interface 204, the USB interface 205, the network interface 206, and the expansion slot 207. The main board 213 may be designed to be a separate entity from other parts of the printer 200 as shown by the dotted line in FIG. 2.

The parallel interface 204, the USB interface 205, and the network interface 206 are connected to a network and external apparatuses 220 via a bi-directional link. The paper feed unit 211, and the print engine 212 are bi-directionally connected to the engine controller 208. A print output 230 is carried out from the paper feed unit 211.

The configuration of the printer 200 shown in FIG. 2 differs from conventional printers in that the second information processing unit 210 as a sub processor can be installed in the expansion slot 207. Here, the configuration of FIG. 2 shows a state wherein the sub processor 210 has been installed for explanation purposes. Further, the printer 200 is assumed to be a color printer, and PDL data input from an external interface shall be compressed for transfer-time shortening.

When power is supplied to the printer 200 in this state, whether the sub processor 210 is installed in the socket 209 in the expansion slot 207 is checked mechanically or electrically during boot-up. If it is determined that the sub processor 210 is installed, the fact thereof is displayed on the display and input unit 203.

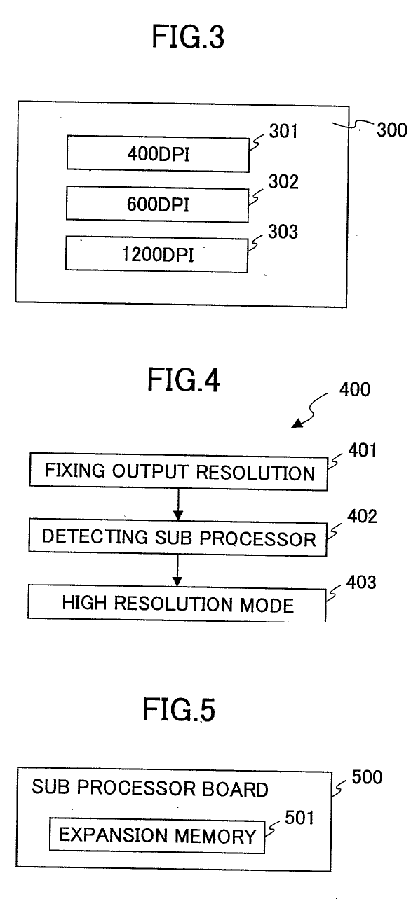

FIG. 3 is a figure showing an example of a variation of the embodiment of the printer in FIG. 2. Output resolution of a printer 300 in FIG. 3 is selective, whether or not a sub processor is installed. The example provides selective resolution values 400DPI 301, 600DPI 302 and 1200DPI 303. In this manner, a user can choose one of the resolution values 400DPI 301, 600DPI 302 and 1200DPI 303.

FIG. 4 is a figure showing an example of a variation of the embodiment of the printer in FIG. 2. The variation of FIG. 4 may be configured such that resolution is fixed 401, if the printer 400 determines that there is no sub processor available, and only when a sub processor is detected and available 402, a higher output mode 403 is offered.

FIG. 5 is a figure showing an example of a variation of the embodiment of the printer in FIG. 2. In FIG. 5, if the printer allows the use of a high resolution mode only when a sub processor is installed, a sub processor board 500 may provide an extended memory 501. In this manner, a higher resolution with a stable operation can be attained.

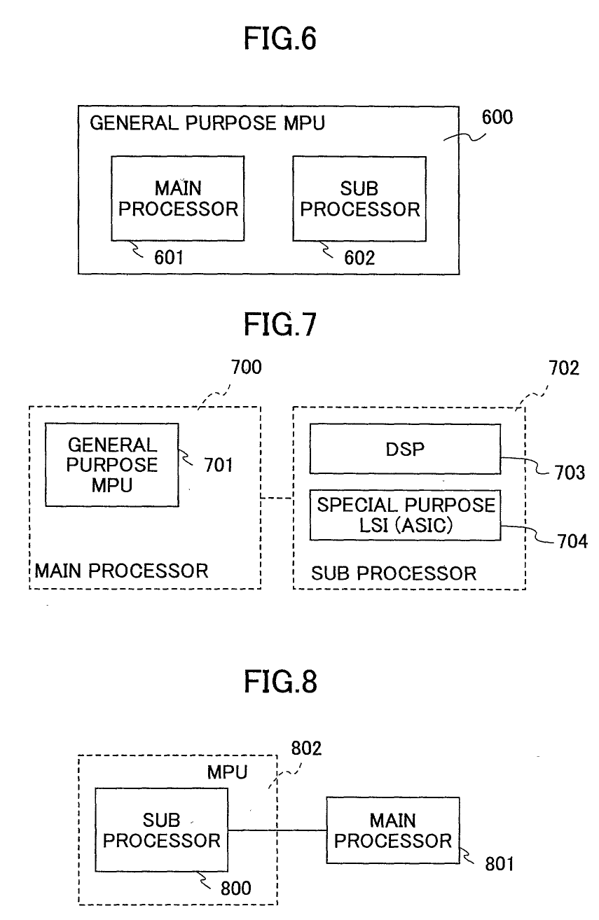

FIG. 6 is a figure showing an example of a variation of the embodiment of the printer in FIG. 2. In FIG. 6, a main processor 601 and a sub processor 602 are implemented by a general-purpose MPU 600. In this manner, the general-purpose MPU 600 can be used effectively, contributing to a reduction in cost.

FIG. 7 is a figure showing an example of a variation of the embodiment of the printer in FIG. 2. As shown in FIG. 7, a main processor 700 is implemented by a general-purpose MPU 701, while a sub processor 702 is implemented by a DSP 703 or a specific purpose LSI (ASIC) 704. In this manner, functions of the sub processor 702 can be adjusted according to specification requirements and ability of the main processor 700.

FIG. 8 is a figure showing an example of a variation of the embodiment of the printer in FIG. 2. In FIG. 8, the distribution ratio of processing load of a sub processor 800 over a main processor 801 is at the liberty of a system designer who should optimize the performance-to-cost ratio and overall performance. For example, if the sub processor 800 is implemented by an MPU 802 that offers an overwhelmingly higher speed than the main processor 801, the sub processor 800 can perform all internal processes, including printing flow.

In this case, as far as the printer is concerned, the sub processor 800 can take all control subsequent to boot-up, stopping the main processor 801.

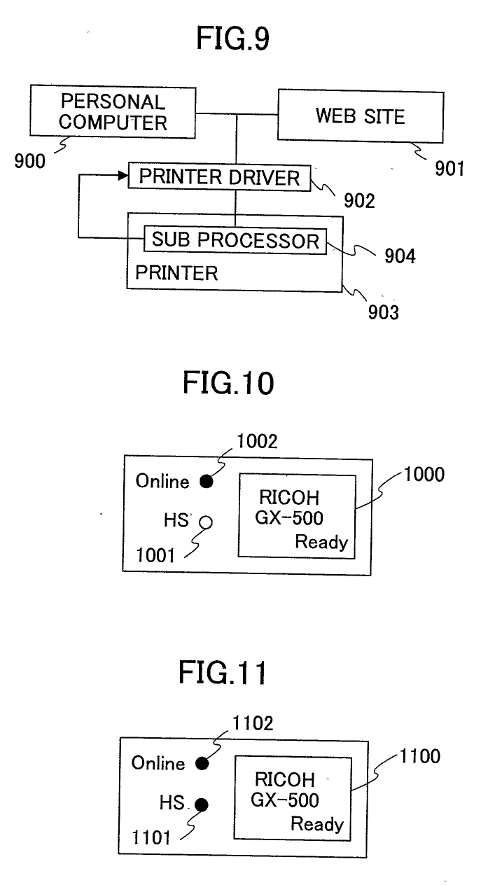

FIG. 9 is a figure showing an example of a variation of the embodiment of the printer in FIG. 2. When a sub processor 904 in FIG. 9 is available, resolution higher than what is initially available in a printer 903 can be offered to a user. In this case, a configuration can be such that status of the printer 903 is supplied from a printer driver 902 on a user apparatus, such as a personal computer 900, a Website 901, and the like. In this manner, it also becomes possible to suspend a high-resolution mode when the sub processor 904 is not available.

According to the embodiments and the variations thereof described above, a sub processor can be added when required. Further, by preparing sub processors with different performance and costs, a choice can be offered for users to select an optimum sub processor.

In the description above, the example of the embodiments and the variation thereof is based on a color printer, however, the present invention can be applied to a monochrome machine.

[Example of Printer Status Display]

FIG. 10 is a figure showing an example of status display 1000 of the printer in FIG. 2. In FIG. 10, status when there is no sub processor installed is shown. The high-speed lamp display HS 1001 is dark in the display example of the printer status 1000 in FIG. 10, while an online lamp 1002 is bright.

FIG. 11 is a figure showing an example of the printer status display in FIG. 2. In FIG. 11, status 1100 after carrying out boot-up, when there is a sub processor installed, is shown. In the status 1100 when there is a sub processor, both a high-speed lamp (HS) 1101 and an online lamp 1102 are bright as shown in FIG. 11, indicating that a high-speed service is available. The method of a display is not limited to this but other techniques are also possible.

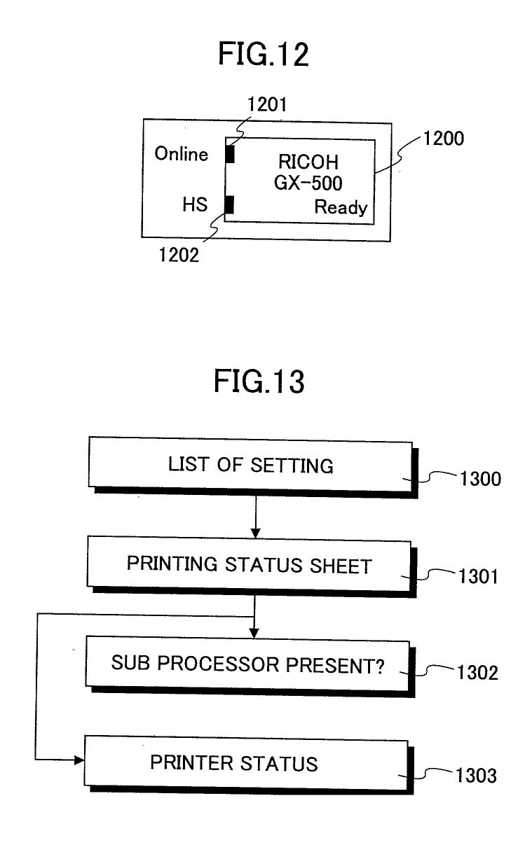

FIG. 12 is a figure showing a display example of status of the printer in FIG. 2. As shown in FIG. 12, small areas 1201 and 1202 of a liquid crystal panel 1200 may used to indicate the status. Thus, a wide display screen can be adopted, eliminating the lamps.

FIG. 13 is a figure showing a display example of status of the printer in FIG. 2. A setting list 1300 of the printer can be printed as printing status sheet 1301, whereby whether or not a sub processor is installed is indicated 1302 as shown in FIG. 13. In this manner, the status of the printer is ascertained 1303 from the status sheet.

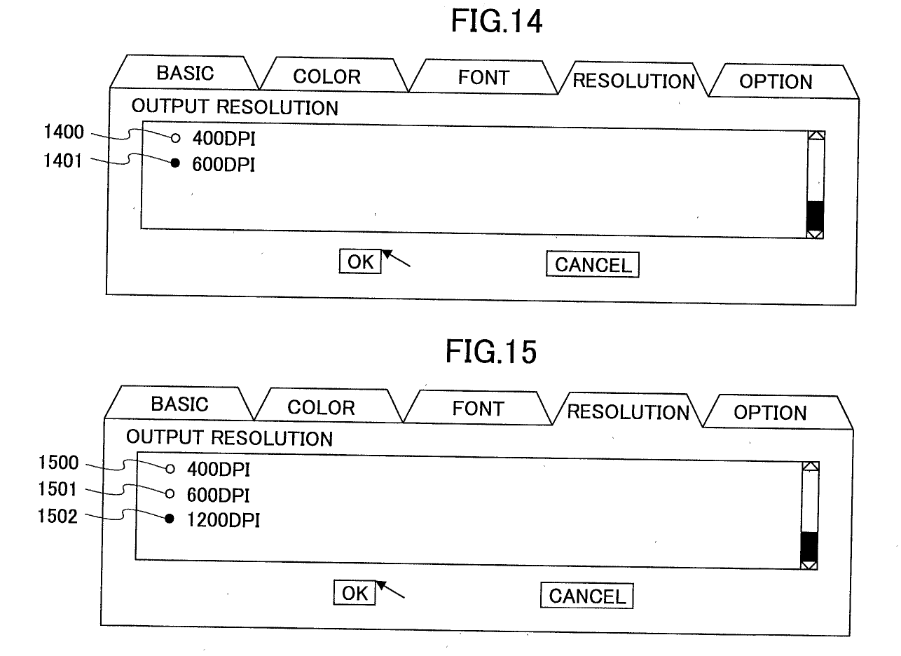

FIG. 14 is a figure showing a display example of status of the printer in FIG. 2. The display example shown in FIG. 14 represents the case where no sub processor is installed. Here, an output resolution value 600DPI 1401 can be chosen from resolution values 400DPI 1400 and 600DPI 1401.

FIG. 15 is a figure showing a display example of status of the printer in FIG. 2. The display example shown in FIG. 15 represents the case where a sub processor is installed. Here, an output resolution value 1200DPI 1502 can be chosen from resolution values 400DPI 1500, 600DPI 1501, and 1200DPI 1502.

[Operation of Image Outputting System]

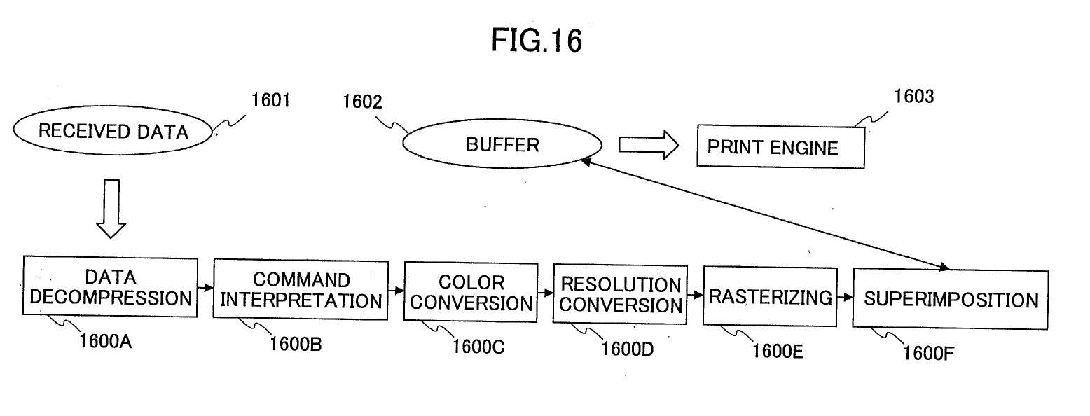

Next, operation of the image outputting system of the first embodiment of the present invention is described. FIG. 16 is a figure describing operations when applying the image outputting system of the first embodiment of the present invention to a printer.

In FIG. 16, printing operations when no sub processor is installed is shown. Data 1601 received from an external source via an interface is processed by step 1600A, step 1600B, step 1600C, step 1600D, step 1600E and step 1600F, that is similar to general color printer operations, and stored to a buffer 1602. After the data are received at least for one page by the buffer 1602, the data are transferred to a print engine 1603 and printing is performed.

More specifically, the received data are decompressed at step 1600A in FIG. 16, and converted into usual PDL data. At step 1600B, a command interpretation of the PDL data is carried out, and objects such as text, a graphic, and a bit map are generated.

Further, predetermined color conversion of the objects is performed at step 1600C, and resolution conversion is performed according to resolution of the print engine at step 1600D. Furthermore, after rasterizing half tones and the like at step 1600E, superimposition of each of the objects is performed at step 1600F.

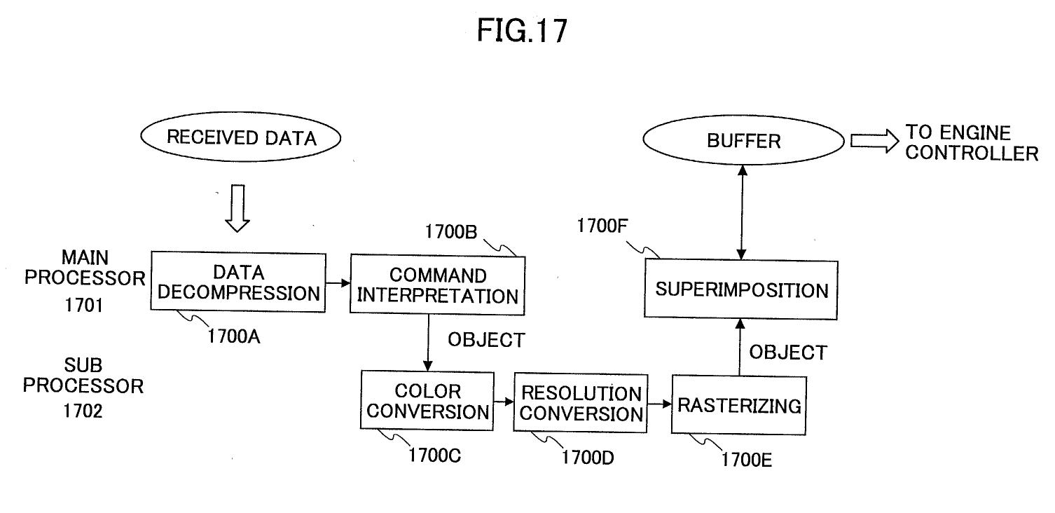

FIG. 17 is a figure describing operations when applying the image outputting system in the first embodiment of the present invention to a printer. A difference between the processes of FIG. 16 and FIG. 17 is that a sub processor 1702 is employed in addition to a main processor 1701 in FIG. 17, and selected steps are performed by the sub processor 1702. In this example, the sub processor 1702 performs step 1700C, step 1700D and step 1700E. Since exchange of data between the main processor 1701 and the sub processor 1702 is carried out on an object-by-object basis, program control is simplified.

A system designer has a choice as to which of step 1700A, step 1700B, step 1700C, step 1700D, step 1700E and step 1700F shall be processed by the sub processor 1702. Optimum distribution of load of the processes varies depending on the performance capacity of the sub processor, the relative capacity of the sub processor to the main processor, the allowable price for the sub processor, a PDL processing system, and the like.

Generally, the load of the process is the heaviest with step 1700E, i.e., rasterizing, then step 1700C, and then step 1700D in the case of a color page printer. According to this example of the embodiment, step 1700C, step 1700D and step 1700E are assigned to the sub processor 1702. Alternatively, the sub processor 1702 may perform only step 1700D and step 1700E, and other combinations are possible.

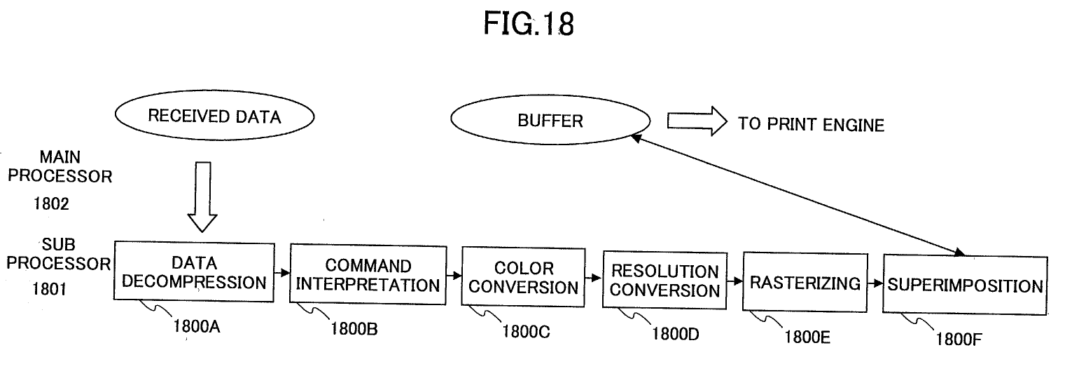

FIG. 18 is a figure describing operations when applying the image outputting system of the first embodiment of the present invention to a printer. FIG. 18 represents the case wherein a sub processor 1801 is installed in addition to a main processor 1802. Further, all of step 1800A, step 1800B, step 1800C, step 1800D, step 1800E and step 1800F are performed by the sub processor 1801, which differs from the configuration shown in FIG. 17. Exchange of data between the main processor 1802 and the sub processor 1801 is carried out on an object-by-object basis, facilitating program control.

A second embodiment of the image outputting system including the image outputting apparatus of the present invention is described hereunder.

[Image Output Configuration of System]

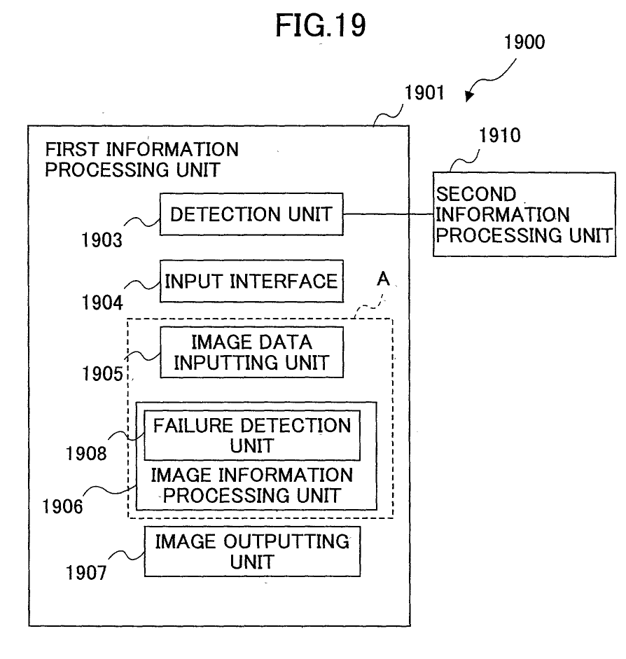

FIG. 19 is a block diagram of the image outputting system of the second embodiment of the present invention.

An image outputting system 1900 in FIG. 19 includes a first information processing unit 1901, a second information processing unit 1910, a detection unit 1903, an input interface unit 1904, an image data input unit 1905, an image information processing unit 1906, and an image outputting unit 1907.

The first information processing unit 1901 carries out first information processing. The second information processing unit 1910 is detachable from the first information processing unit 1901, and carries out second information processing. The detection unit 1903 included in the first information processing unit 1901 detects status of the second information processing unit 1910.

The input interface unit 1904 is capable of receiving two or more image data streams. The image data input unit 1905 receives at least one image data stream input from the input interface unit 1904. The image information processing unit 1906 and the image data input unit 1905 are configured in one body, and process image data. The image outputting unit 1907 provides an image output in predetermined output resolution based on a detection output from the detection unit 1903, and the image output.

The input interface 1904 adjusts the data transfer rate of the image data such that the first information processing and the second information processing are carried out. Further, the data processing speed of the image information processing unit 1906 is set at a speed higher than the data transfer rate of the input interface 1904.

Image data processing of the image information processing unit 1906 includes color conversion processing, resolution conversion processing, and rasterizing processing. The Input interface 1904 is detachable from the image information processing unit 1906. In the image information processing unit 1906, a failure detection unit 1908 that detects a failure in image information processing is included, thereby a failure, if any, of the image information processing unit 1906 is detected in advance of a printing process. An image information processing unit 1906 that has a failure is not employed.

[Composition of Printer]

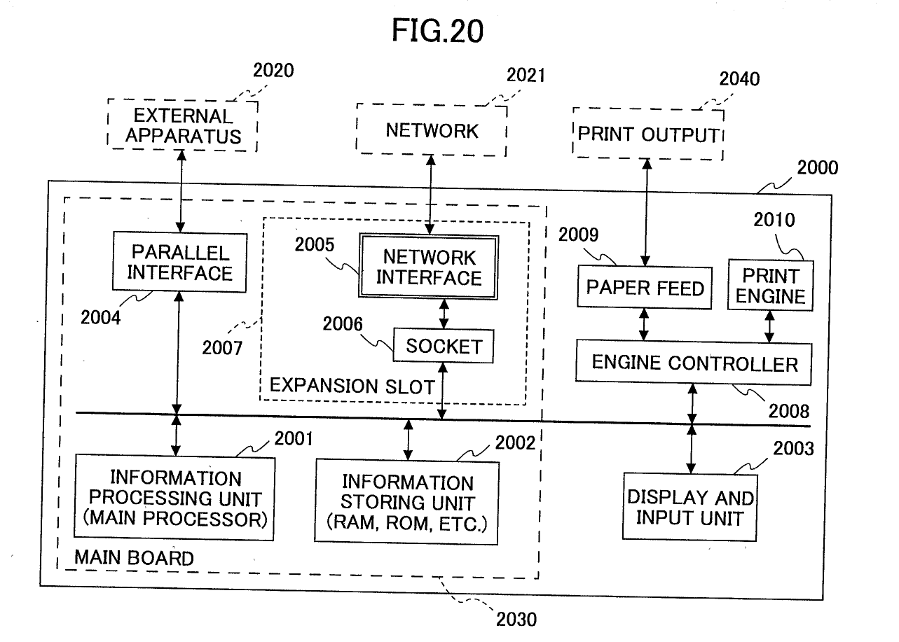

FIG. 20 is a block diagram showing a specific configuration of the second embodiment of the present invention. FIG. 20 shows the image outputting system as applied to a printer 2000. The printer 2000 includes an information processing unit (main processor) 2001, an information storage unit 2002 that includes RAM, ROM, and the like, a display and input/output unit 2003, a parallel interface (parallel I/F) 2004, a network I/F card 2005, a socket 2006, an expansion slot 2007 and an engine controller 2008, all of which are connected to a bus line of the printer 2000, either directly or indirectly, as shown in FIG. 20.

The network I/F card 2005 in the printer 2000 performs communications processing. The information processing unit 2001 includes CPU etc., and controls information processing and an overall operation. The information storage unit 2002 includes a ROM that stores various control programs necessary for printing process, initial values and the like, a RAM for working space, and the like.

The engine controller 2008 controls a paper feed unit 2009, and a print engine 2010. The display and input/output unit 2003 includes a display and control panel, and switches.

The information processing unit 2001, the information storage unit 2002, the parallel interface 2004, and the expansion slot 2007 are formed on a main board 2030. The main board 2030 is configured separately from other parts of the printer 2000.

The parallel interface 2004 and the network interface card 2005 are connected to external apparatuses and a network 2021, respectively, by a bi-directional connection. The network 2021 is connected to an external apparatus 2020. Furthermore, the paper feed unit 2009, and the print engine 2010 are bi-directionally connected to the engine controller 2008, and a printed output 2040 is output from the paper feed unit 2009.

When power is supplied to the printer 2000, status of the socket 2006 in the expansion slot 2007 is detected mechanically or electrically during boot-up. When a sub processor is detected as installed in the socket 2006, a fact thereof is displayed on the display and input/output unit 2003.

In the above, descriptions are made based on a color printer, however, the present invention also applies to a monochrome printer.

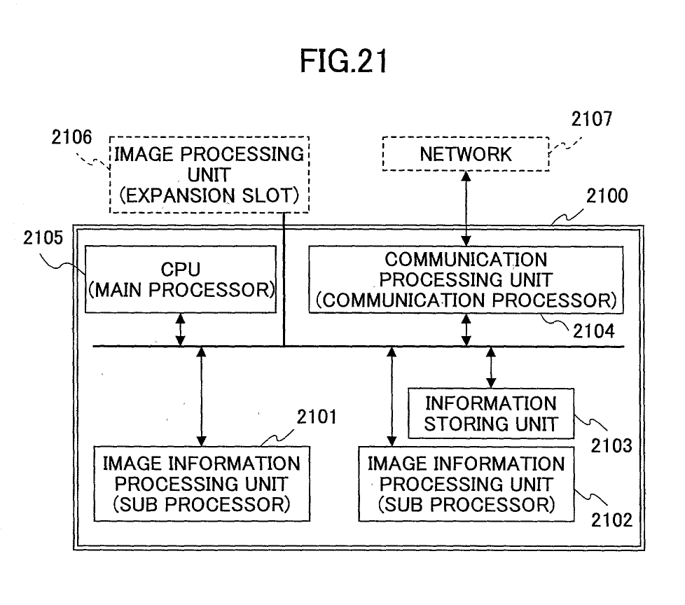

FIG. 21 is a block diagram showing an example of the second embodiment of the present invention. As shown in FIG. 21, the second embodiment includes sub processors 2101 and 2102 that are the image information processing units, an information storage unit 2103 that further includes ROM, RAM, and the like, a communication processor 2104, and a CPU (main processor) 2105, all of which are connected by a bi-directional bus line and mounted on a board 2100. Further, a network 2107 is connected to the communications processing unit 2104 through wires or wirelessly. Further, an external image processing system 2106 in an expansion slot is connected to the bus line.

Having the sub processors 2101 and 2102 as the image information processing unit in addition to the CPU (main processor) 2105 differs from general printers. Descriptions are made based on a color printer, however, the present invention also applies to a monochrome printer. Here, PLD data input from the external apparatuses are assumed to be compressed so that a transfer time to the printer is shortened, and is not in CMYK form that is a color space peculiar to a printer.

[Operation of Printer that is Image Outputting System]

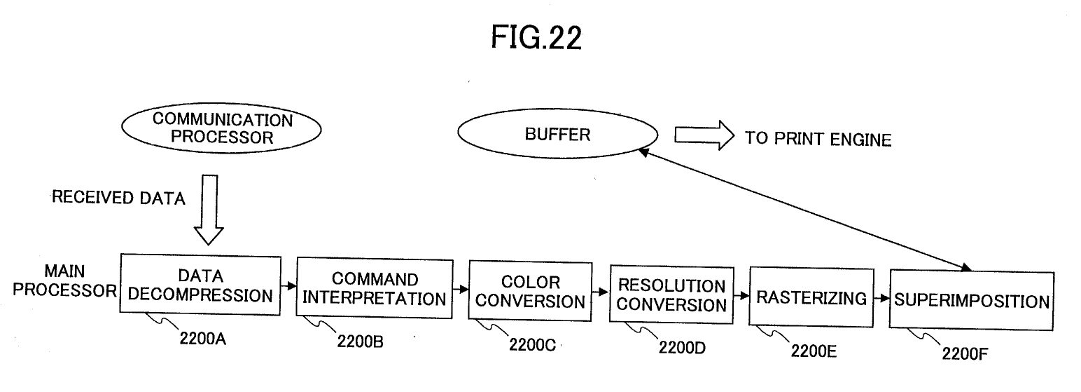

Next, operation of the image outputting system of the second embodiment of the present invention is described. FIG. 22 is a figure describing operations when applying the image outputting system in the second embodiment of the present invention to a printer.

In this embodiment, a main processor performs process step 2200A, step 2200B, step 2200C, step 2200D, step 2200E and step 2200F. Data received from an external apparatus via an interface are processed through step 2200A, step 2200B, step 2200C, step 2200D, step 2200E and step 2200F, that is similar to general printers. The processed data are stored in a buffer. When data sufficient for at least one page are stored in the buffer, the data are transferred to the engine controller, and printing is performed.

Specifically, compressed data received from the communication processor 2104 are decompressed at step 2200A, and a command interpretation is carried out at step 2200B. At step 2200C, color conversion is performed, and resolution conversion is carried out in step 2200D. At step 2200E, rasterization is performed. The data in the buffer and the rasterized data are superimposed at step 2200F. The processed data are temporarily stored in the buffer, and output to the print engine such-that an image is output.

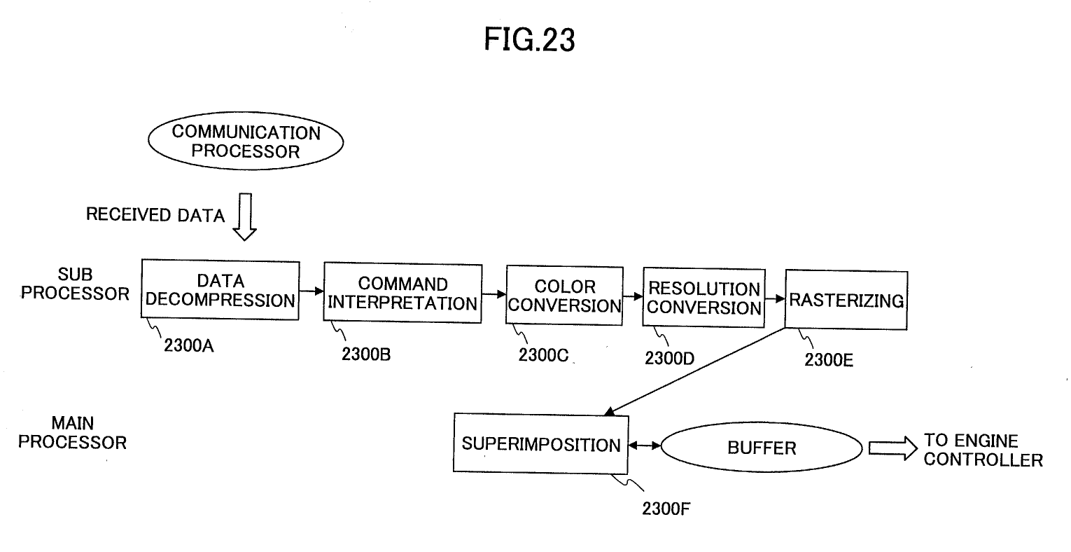

Printing operation of FIG. 23 is described hereunder. FIG. 23 is a figure describing operations when applying the image outputting system in the second embodiment of the present invention to a printer. Here, a sub processor executes step 2300A, step 2300B, step 2300C, step 2300D, and step 2300E, and a main processor executes step 2300F. Data processed in this manner are stored in a buffer, and transferred to an engine controller so that printing is performed.

In general printers, a main processor performs all the processing load of step 2300A, step 2300B, step 2300C, step 2300D, step 2300E and step 2300F. Conversely, the present embodiment uses two sub processors that share the processing load in parallel.

Descriptions follow for step 2300A, step 2300B, step 2300C, step 2300D, step 2300E and step 2300F in this sequence. In FIG. 23, at step 2300A, decompression of the received data, and conversion to a standard PDL command are performed by the sub processor. At step 2300B, the PDL command is interpreted, and objects, e.g., text, a graphic, a bit map, etc. are generated.

At step 2300C, predetermined color conversion is performed to the generated objects, and resolution conversion is performed according to resolution of a print engine at step 2300D. At step 2300E, rasterizing including a half tone process is performed. Then, a superimposition process of the objects is performed at step 2300F by the main processor. Here, data exchange between the main processor and the sub processor is carried out on an object-by-object basis.

The PDL command interpretation process of step 2300B provides generated objects to the sub processor in an idle state one by one, making program control easy. A system designer can determine an appropriate load distribution between the main processor and the sub processor, without being limited to the example of FIG. 23.

Which of step 2300A, step 2300B, step 2300, step 2300D, step 2300E and step 2300F should be performed by the sub processor varies by the relative capability of the sub processor to the main processor, allowable cost of the sub processor, a PDL processing system and the like. However, generally, rasterizing of step 2300E has the heaviest load in overall information processing of a color page printer. Conversely, processing loads of step 2300A, step 2300B and step 2300F are considered relatively light.

Although the sub processor performs step 2300A, step 2300B, step 2300C, step 2300D and step 2300E in the present embodiment, a configuration may be such that the sub processor performs only step 2300D and step 2300E. Here, the internal configuration of the main processor and the sub processor are arbitrary.

For example, both processors may be configured by a general purpose MPU. Alternatively, the main processor may be implemented by a general purpose MPU and the sub processor is implemented by a DSP, a specific purpose LSI (ASIC) and the like. If the sub processor is implemented by a specific purpose LSI, each function may be packaged into an ASIC.

For example, step 2300C requires a large amount of table referencing, and step 2300D requires a large amount of calculation, which makes it conceivable that each step is implemented by an independent chip. Further, a system designer may determine the number of sub processors to be installed in a printer, taking cost, performance level, bus traffic, etc., into consideration.

In the above embodiment, data are exchanged on an object-by-object basis between the main processor and the sub processor. However, depending on PDL processing systems, a collection of objects may be exchanged on a band-by-band basis, and a page-by-page basis.

In this case, the PDL processing system needs to support object drawing on the band-by-band basis, and a printer driver of a client device (not shown) also needs to be able to issue commands of the object drawing on the band-by-band basis. Accordingly, the number of sub processors may be three or more.

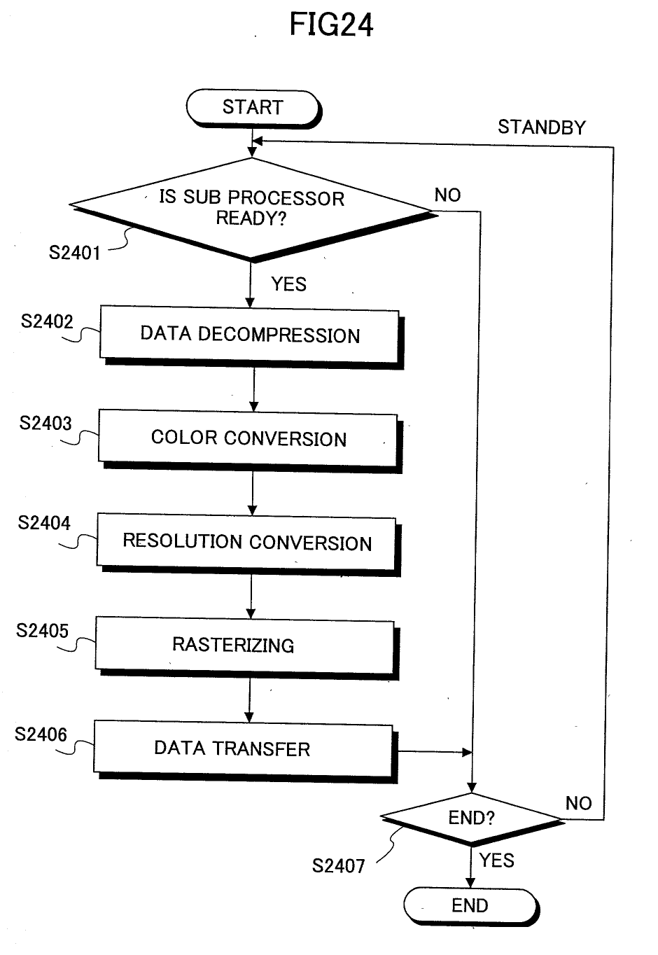

FIG. 24 is a-flowchart describing operations when applying the image outputting system in the second embodiment of the present invention to a printer.

First, whether the sub processor is operating is checked at step S2401.

If the sub processor is found to be operating, process progresses to next step S2402, and data decompression is performed. Then, at step S2403, color conversion is performed, and at step S2404, resolution conversion is performed. Further, at step S2405, rasterizing is performed. At step S2406, data are transferred. Then, whether data transmission is finished is checked at step S2407. If the checking result indicates that the data transmission is finished, the above process is finished. Otherwise, the process returns to step 2401 after standby for a predetermined period.

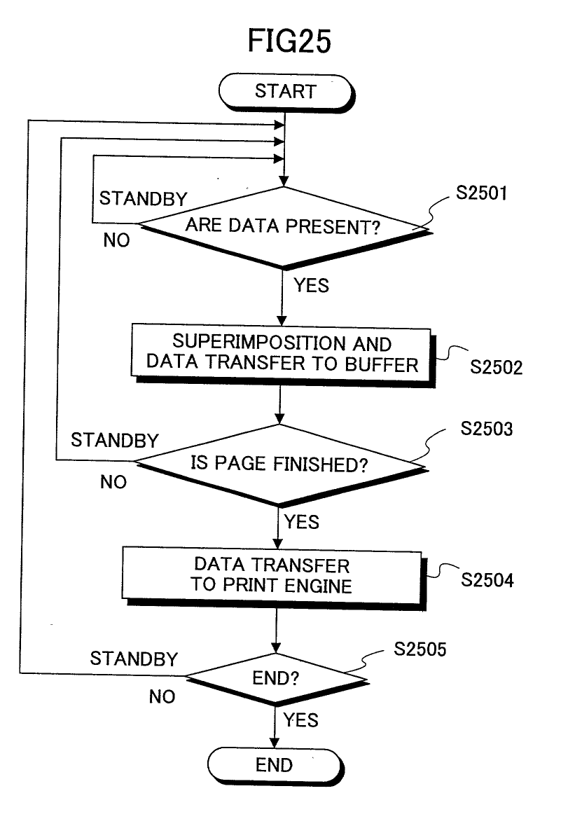

FIG. 25 is a flowchart describing operations when applying the image outputting system of the second embodiment of the present invention to a printer. The process of FIG. 25 takes place after the process of FIG. 24. At step S2501, whether there are data is checked. If data are present, the process progresses to step S2502, wherein superimposition and transmission to a buffer are carried out.

Next, at step S2503, whether there is a page end is checked. If a page end is found, the process progresses to step S2504, wherein the data are transferred to a print engine. If it is determined that there are no data at step S2501, the process waits and step S2501 is repeated. Similarly, if it is determined that there is no page end at step S2503, the process waits, and step S2501 is repeated.

At step S2504, after transferring the data to the print engine, whether the transmission is completed is checked. If it is determined that the transmission is completed, the process ends. Otherwise, step S2501 is repeated after standby of a predetermined period.

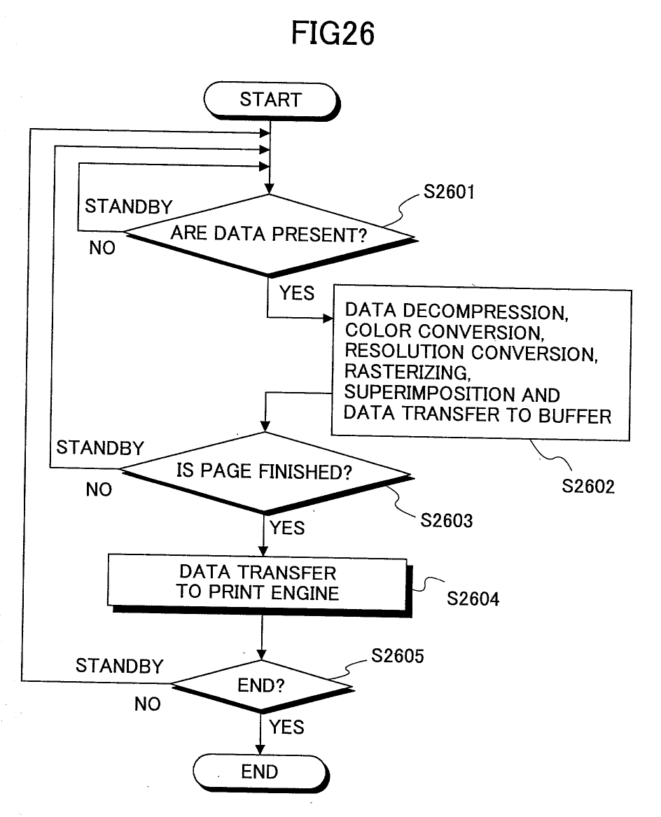

FIG. 26 is a flowchart describing operations when applying the image outputting system of the second embodiment of the present invention to a printer. FIG. 26 describes the flow of the process in FIG. 25 more in detail. The flow starts with step 2601, wherein whether there are data is checked. If data are present, the process progresses to step 2602, wherein data decompression, color conversion, resolution conversion, rasterizing, superimposition, and transmission to the buffer are performed in this sequence.

Next, at step S2603, whether there is a page end is checked. If it is determined that the page end is present, the process progresses to step S2604, wherein the data are transferred to the print engine. Conversely, if it is determined that there are no data at step S2601, the process returns to step S2601 after standby for a predetermined period. If it is determined that there is no page end at step S2603, the process returns to step S2601 after standby for a predetermined period.

After transferring the data to the print engine at step S2604, whether the transmission is completed is checked. If the transmission is completed, the process ends. Otherwise, the process returns to step S2601 after standby for a predetermined period.

[Composition in Image Outputting System of First Variation of Second Embodiment]

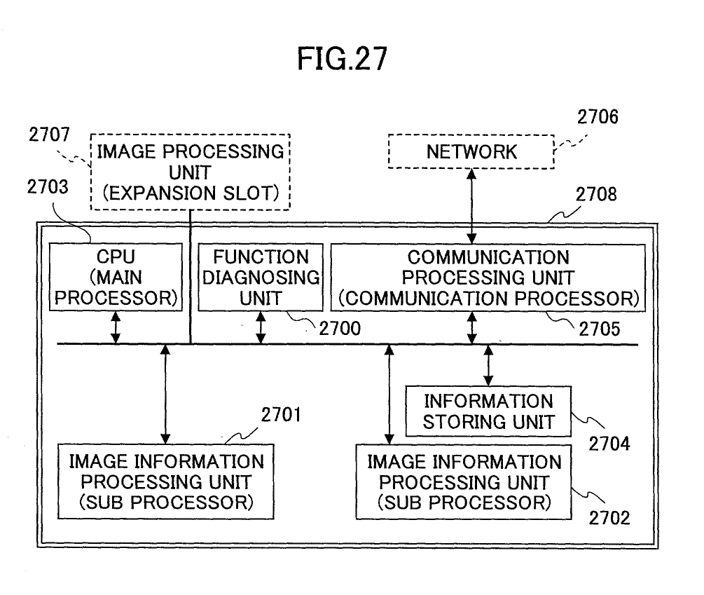

FIG. 27 is a block diagram of a principal part of the image outputting system that is a first variation of the second embodiment of the present invention.

The difference between the second embodiment and the first variation thereof is that a function diagnosing unit 2700 provides a test signal to sub processors 2701 and 2702, checks operating status, and returns information relative to the operation status to a CPU 2703 that is a main processor. In the CPU 2703, future printing process is determined by the status information of the sub processors 2701 and 2702 that the function diagnosing unit 2700 returns.

For example, if the both sub processors 2701 and 2702 are unavailable, the CPU 2703 performs all processing, like a general color printer. If the both sub processors 2701 and 2702 are available, the same process as the second embodiment takes place, which will not be repeated here.

[Operation of First Variation of Second Embodiment]

In order to facilitate descriptions, the image outputting system here is compliant with a color printer, and PDL data input from an external interface is compressed such that a faster data transfer to the printer is obtained, and is not in CMYK format and the like that are a printer-specific color space. Further, there are two sub processors installed.

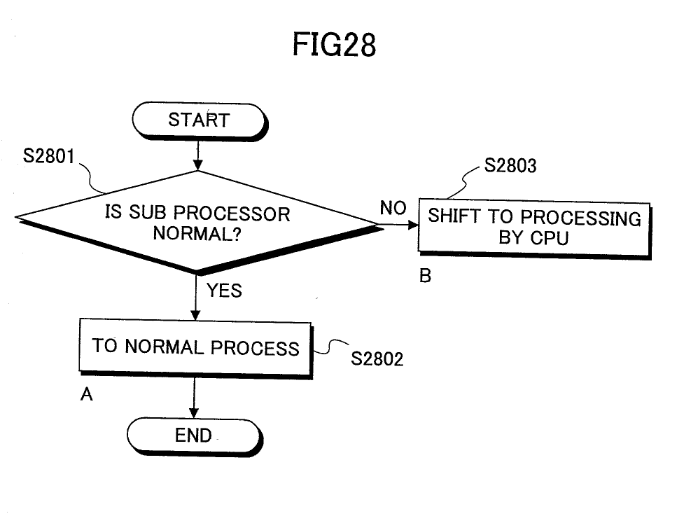

FIG. 28 is a flowchart describing operations when applying the image outputting system of the first variation of the second embodiment of the present invention to a printer. At step 2801, whether the sub processors are operating normally is checked. This checking process is carried out in the function diagnosing unit (abnormality detection unit) 2700 in FIG. 27.

If it is determined that the sub processors are operating normally, the process progresses to step S2802, a normal process A takes place, that is the same as FIGS. 24 and 25 of the second embodiment. If it is determined that there is an abnormality in the sub processors, the process progresses to B of step S2803, that is, the main processor carries out the process.

The difference from the second embodiment is that the system here generally performs diagnosis of the sub processors before the printing process starts. The main processor 2703 transfers a test signal to each of the sub processors, and carries out the diagnosis by checking the response of the sub processors to the test signal. If the sub processors are normal, the response result of each sub processor is set to 11111, and future process is the same as the case of the second embodiment.

In the case that the result from one of the sub processors is “0”, indicating that the sub processor has a failure, the main processor CPU changes the printing process using only a processor that is operating normally. Furthermore, if the response result from the both sub processors is “0”, all printing processes are performed by the main processor CPU, like a general color printer.

[Composition of Printer of Second Variation of Second Embodiment]

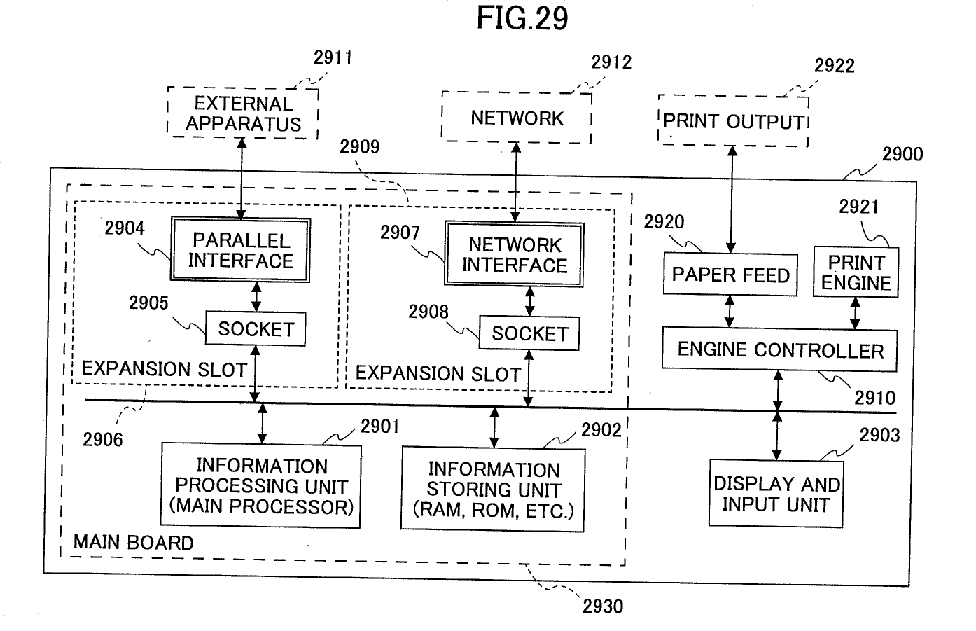

FIG. 29 is a block diagram describing a specific configuration of a second variation of the second embodiment of the present invention. The image outputting system in FIG. 29 is applied to a printer 2900. The printer 2900 includes a main processor (information processing unit) 2901, an information storage unit 2902 that includes a RAM, a ROM, etc., a display and input/output unit 2903, an expansion slot 2906 that includes a parallel interface card 2904 and a socket 2905, an expansion slot 2909 that includes a network interface card 2907 and a socket 2908, and an engine controller 2910, that are connected via a bus line, as shown in FIG. 29.

The network interface card 2907 carries out communications with a network 2912. The parallel interface card 2904 processes signals with an external apparatus 2911. The information processing unit 2901 controls information processing and the overall operation. The information storage unit 2902 includes a ROM that stores various programs necessary for a printing process and initial system values and the like, a RAM that provides a working area, and the like.

The engine controller 2910 controls the paper feed unit 2920, and the print engine 2921. The paper feed unit 2920 outputs printed output 2922. The display and input/output unit 2903 includes a display and control panel, and switches.

The sockets 2905 and 2908 provided in the expansion slots 2906 and 2909, respectively, are bi-directionally connected to the bus line. A main board 2930 includes the information processing unit 2901, the information storage unit 2902, and the expansion slots 2906 and 2909. The main board 2930 is separately configured from other parts of the printer 2900.

The parallel interface card 2904 and the network interface card 2907 are connected to the external apparatus 2911 and the network 2912, respectively, through bi-directional circuits. The engine controller 2910 is connected bi-directionally to the paper feed unit 2920, and the print engine 2921. The paper feed unit 2922 outputs printed output 2922.

The configuration of FIG. 29 differs from a general printer in that the former is capable of installing the parallel interface card 2904 and the network interface card 2907 in the expansion slots 2906 and 2909, respectively, of the printer 2900. In order to facilitate the explanation, the configuration of FIG. 29 is such that the printer 2900 is a color printer and PDL data input from outside is compressed so that transfer time is shortened.

When power is supplied to the printer 2900, status of the sockets 2905 and 2908 in the expansion slots 2906 and 2909, respectively, is checked mechanically or electrically during boot-up. When it is determined that a sub processor is installed and available, the fact thereof is displayed on the display and input/output unit 2903.

In the above explanation, the printer is described as a color printer, however, the present invention also applies to a monochrome printer.

[Composition of Printer of Third Variation of Second Embodiment]

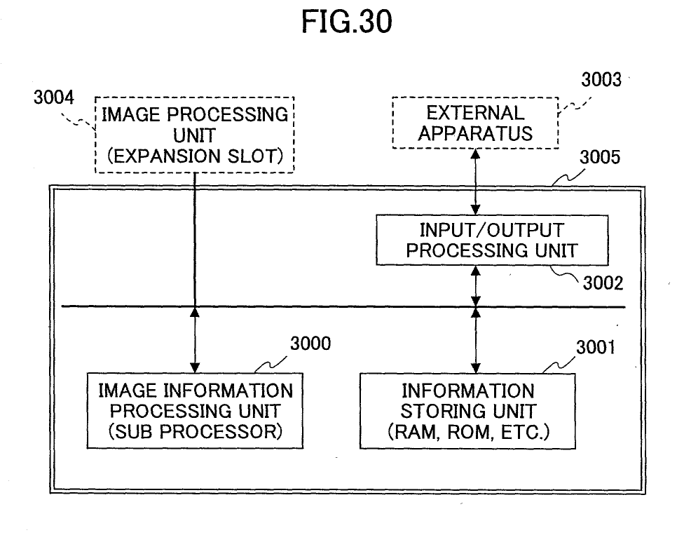

FIG. 30 is a block diagram showing a printer of a third variation of the second embodiment of the present invention. The third variation as shown in FIG. 30 includes a sub processor 3000 that is an image information processing unit, an information storage unit 3001 that includes ROM, RAM and the like, and an I/O processing unit 3002, all of which are connected to a bi-directional bus line. The I/O processing unit 3002 is bi-directionally connected to an external apparatus 3003. An expansion slot 3004 of an external image processing system is connected to the bus line.

[Operation of Printer of Third Variation of Second Embodiment]

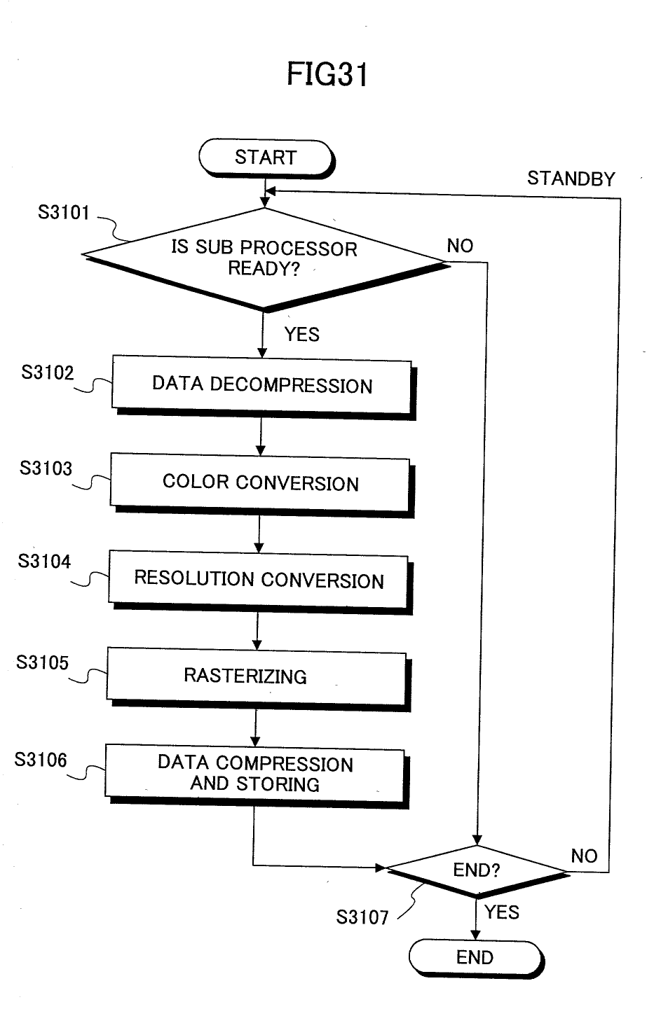

FIG. 31 is a flowchart-describing operations when applying the image outputting system of the third variation of the second embodiment of the present invention to a printer. First, whether the sub processor is operating is checked at step S3101.

If the sub processor is operating normally, the process progresses to step S3102, wherein data are decompressed. Then, the process progresses to step S3103, wherein color conversion is performed, and resolution conversion is performed at step S3104. Then, at step S3105, rasterization is carried out. At step S3106, the process data are compressed and stored. At step 3107, whether the process is finished is checked. If affirmative, the process ends. Otherwise, the process returns to step 3101 after standby for a predetermined period.

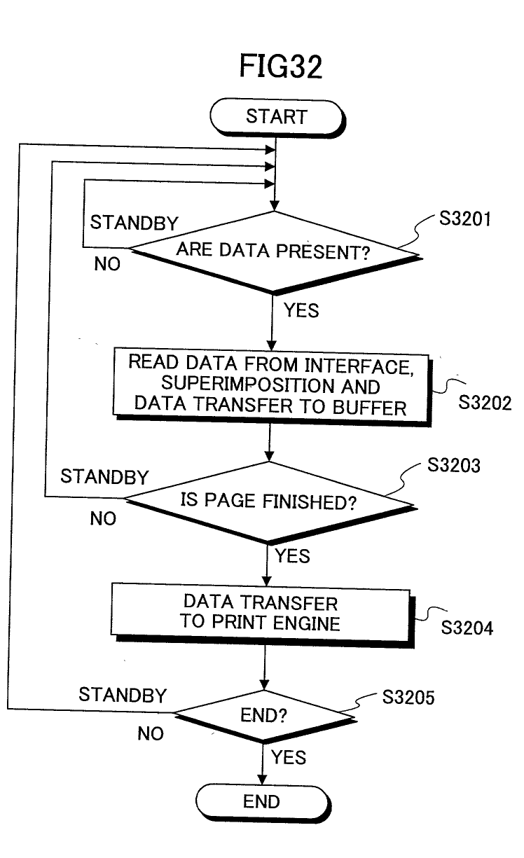

FIG. 32 is a flowchart describing operation when applying the image outputting system of the third variation of the second embodiment of the present invention to a printer. The flow of FIG. 32 is a continuation of the flow in FIG. 31.

At step S3201, whether there are data is checked. If there are data, the data are read from an interface, the read data are superimposed onto data in a buffer, and the superimposed data are transferred to the buffer at step S3202. Next, at step S3203, whether a page is completed is checked.

If affirmative, the process progresses to step S3204, and the superimposed data are transferred to the print engine. At step S3205, whether the data transfer is completed is checked. If the data transfer is completed, the process ends. Otherwise, the process returns to step S3201 after standby for a predetermined period.

[Composition of Printer of Fourth Variation of Second Embodiment]

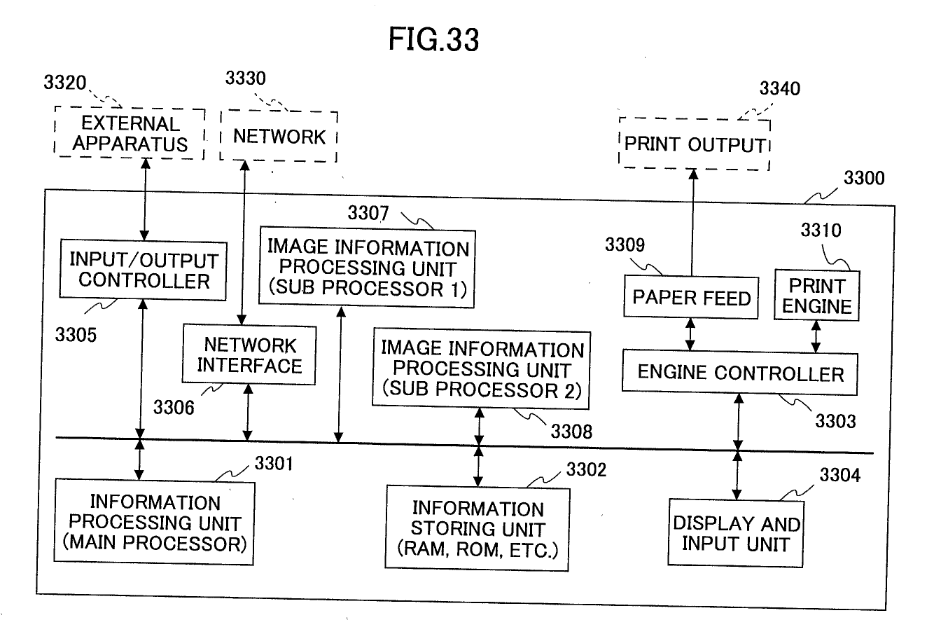

FIG. 33 is a block diagram showing a printer 3300 as a fourth variation of the second embodiment of the present invention. The printer 3300 includes a main processor 3301 that is an information processing unit, an information storage unit 3302 that includes a ROM and a RAM, an engine controller 3303, a display and input/output unit 3304, an I/O controller 3305, a network interface 3306, sub processors 3307 and 3308 as sub processors 1 and 2 for image information processing, respectively, as shown in FIG. 33, all of which are connected by a bi-directional bus line.

Further, the I/O controller 3305 is bi-directionally connected to an external apparatus 3320. The network interface 3306 is connected to a network 3330, either by wires or wirelessly. A paper feed unit 3309, and a print engine 3310 are bi-directionally connected to the engine controller 3303. The print output 3340 is provided by the pager feed unit 3309.

[Operation of Printer of Fourth Variation of Second Embodiment]

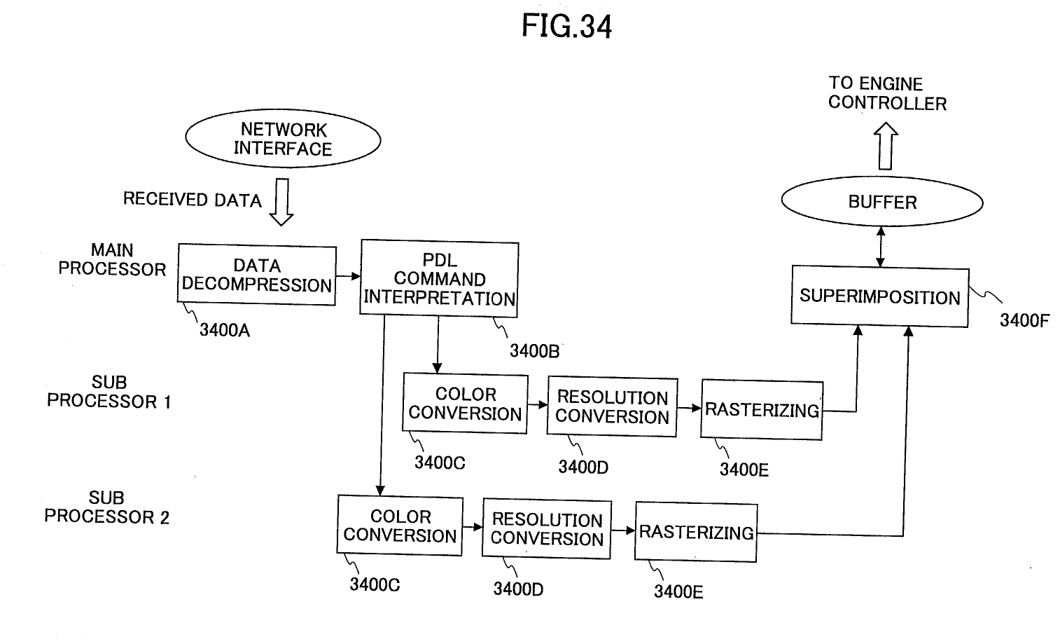

FIG. 34 is describes operations when applying the image outputting system of the fourth variation of the second embodiment of the present invention to the printer 3300. The process shown in FIG. 34 is carried out by the main processor 3301 performing data decompression at step 3400A, PDL command interpretation at step 3400B and superimposition at step 3400F, with the sub processors performing color conversion at step 3400C, resolution conversion at step 3400D and rasterizing at step 3400E in parallel.

Load distribution among the main processor and the two sub processors in FIG. 34 is to be determined by a system designer. Generally, in information processing of a color page printer, the rasterizing step 3400E tends to be the heaviest load, with the color conversion step 3400C and the resolution conversion step 3400D following. According to this example of the fourth variation of the second embodiment, the color conversion 3400C, the resolution conversion 3400D and the rasterizing 3400E are loaded to both the sub processors 1 and 2.

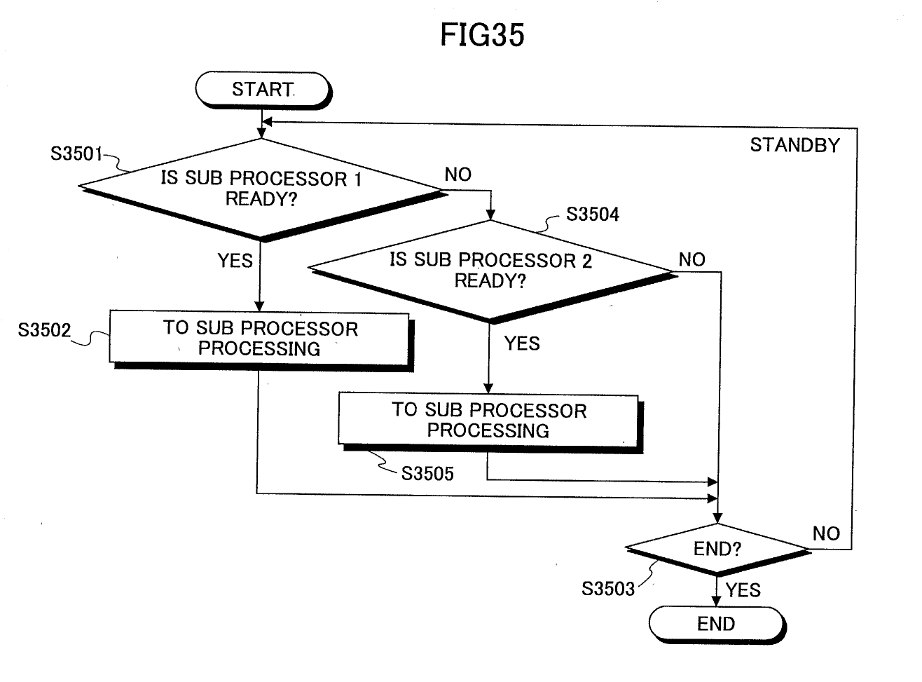

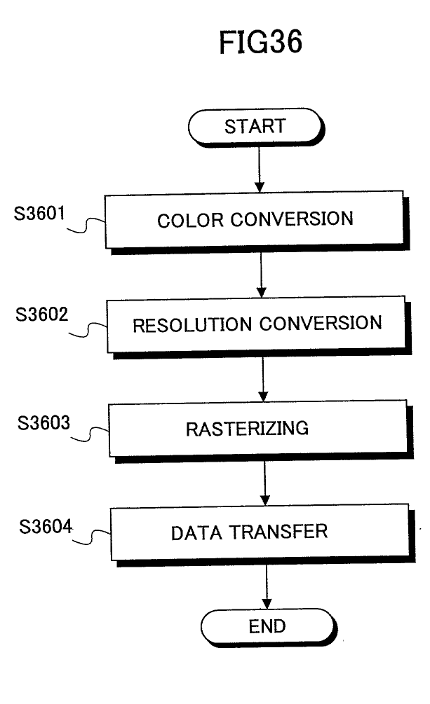

FIG. 35 is a flowchart describing operations when-applying the image outputting system of the fourth variation of the second embodiment of the present invention to a printer. At step 3501, whether the sub processor 1 is normally operating is checked. If affirmative, the process progresses to step S3502, wherein the sub processor 1 performs processing such as color conversion, resolution conversion, rasterizing, and data transfer, according to a process shown in FIG. 36. Then, at step S3503, whether processing is completed is checked.

Conversely, in the case that the sub processor 1 is not operating normally, whether the sub processor 2 is operating normally is checked at step S3504. If the sub processor 2 is operating normally, processes by the sub processor 2 are carried out, the processes being the same as listed above for sub processor 1.

If the sub processor 2 is not operating normally, whether the process is completed is checked at step S3503. If the process is not completed, the process returns to step S3501 after standby for a predetermined period.

FIG. 36 is a flowchart describing operations when applying the image outputting system of the fourth variation of the second embodiment of the present invention to a printer. The operation is to be carried out by the sub processor 1 and the sub processor 2. At step S3601, color conversion is performed, and resolution conversion is performed at step S3602. Then, rasterizing is performed at step S3603, and data transfer is carried out at step S3604. In this manner, the process ends.

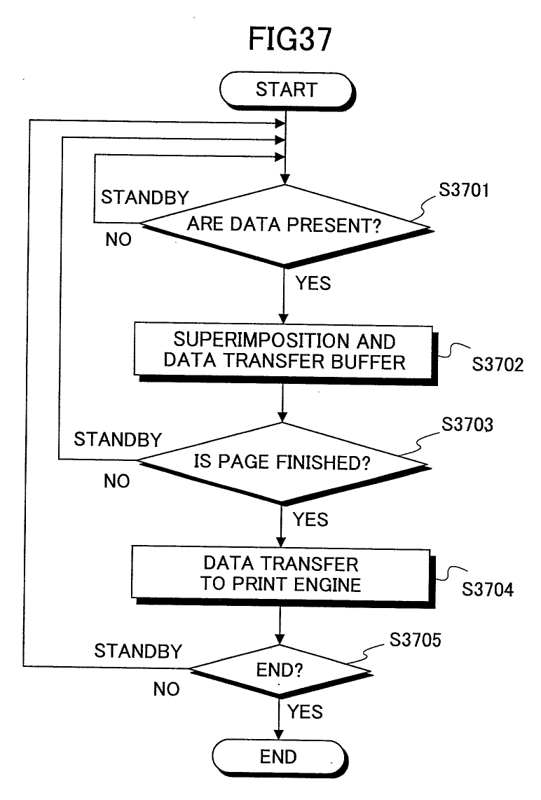

FIG. 37 is a flowchart describing operations when applying the image outputting system in the fourth variation of the second embodiment of the present invention to a printer. The process showed in FIG. 37 is a continuation of the process in FIG. 36. At step S3701, whether there is any data transferred is checked.

If affirmative, the process progresses to following step S3702, wherein the transferred data and data in a buffer are superimposed, and the superimposed data are transferred to the buffer. At step S3703, whether a page is completed is checked. If affirmative, the process progresses to step S3704 and the data are transferred to the print engine.

Next, at step S3705, whether the data transfer is completed is checked. If affirmative, the process ends. In addition, in any one of the cases where there is no data received at step S3701, the page end has not been received at step S3703, and the data transfer is not completed in step S3705, the process returns to step S3701.

[Composition of Printer in Variation of Embodiment]

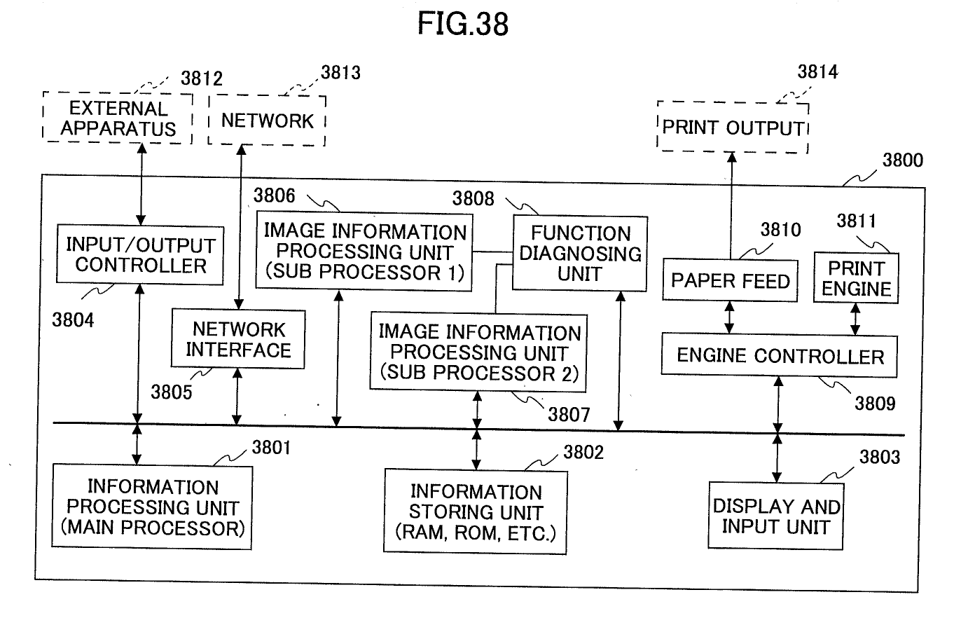

FIG. 38 is a block diagram showing a configuration of an image outputting system as a fifth variation of the second embodiment of the present invention when applied to a printer 3800. In FIG. 38, the printer 3800 includes a main processor 3801 that is an information processing unit, an information storage unit 3802 such as ROM, RAM, etc., a display and input/output apparatus unit 3803, an I/O controller 3804, a network interface 3805, sub processors 3806 and 3807 that are sub processors 1 and 2, respectively, of image information processing units, and a function diagnosing unit 3808 that diagnoses functions based on one of outputs from the image information processing units, and an engine controller 3809, all of which are connected by a bi-directional bus line.

Further, the I/O controller 3804 is bi-directionally connected to an external apparatus 3812. The network interface 3805 is connected to a network 3813, either via wires or wirelessly. A paper feed unit 3810, and a print engine 3811 are bi-directionally connected to the engine controller 3809, and print output 3814 is provided by the paper feed unit 3810.

[Operation of Printer of Fifth Variation of Second Embodiment]

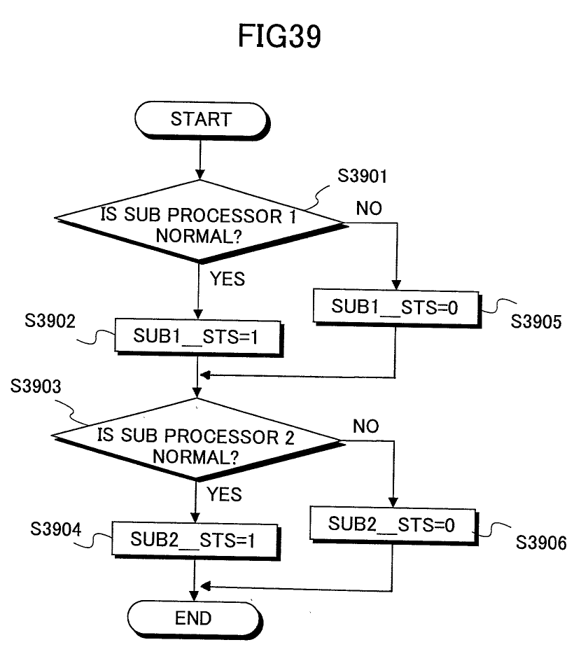

FIG. 39 is a flowchart describing operations when applying the image outputting system of the fifth variation of the second embodiment of the present invention to the printer 3800. The processing in FIG. 39 is distributed such that data decompression, PDL command interpretation, and superimposition are performed by the main processor 3801, and color conversion, resolution conversion, and rasterizing are performed by the two sub processors 3806 and 3807 in parallel.

A system designer may determine beforehand the distribution of the processes between the main processor and the two sub processors in FIG. 39. Generally, in information processing of a color page printer, the heaviest load is said to be rasterizing, with color conversion and resolution conversion following. According to this example of the fifth variation of the embodiment, color conversion, resolution conversion and rasterizing are performed by the sub processors.

FIG. 39 is a flowchart describing operation when applying the image outputting system of the fifth variation of the second embodiment of the present invention to the printer 3800. At step S3901, whether the sub processor 1 is normally operating is checked. If affirmative, the process progresses to step S3902, wherein “1” is set in SUB1_STS, and the process progresses to step S3903, wherein status of the sub processor 2 is checked.

If affirmative, “1” is set in SUB2_STS at step S3904, and the process ends. In addition, if it is determined that the sub processor 1 is not operating normally at step S3901, “0” is set in SUB1_STS at step S3905. Further, if it is determined that the sub processor 2 is not operating normally at step S3903, “0” is set in SUB2_STS at step S3906.

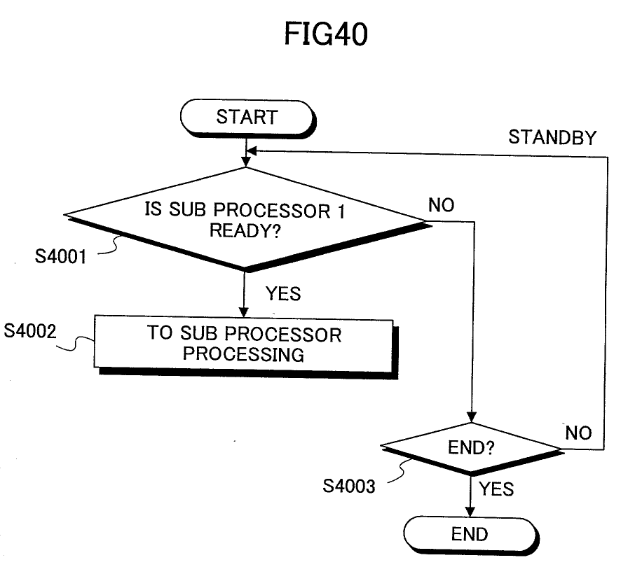

FIG. 40 is a flowchart describing operations when applying the image outputting system of the fifth variation of the second embodiment of the present invention to the printer 3800. The process of FIG. 40 is a continuation to the process of FIG. 39. At step S4001, whether the sub processor 1 is normally operating is checked. If affirmative, the process progresses to step S4002 and the sub processor performs data decompression, color conversion, resolution conversion, rasterizing, and data transfer.

At step S4003, whether the process of the sub processor 1 is completed is checked. If affirmative, the process ends. If it is determined that the sub processor 1 is not operating at step S4001, whether operation of the sub processor 1 is completed is checked at step S4003. If it is determined that the operation of the sub processor 1 is not completed yet in step S4003, the process returns to step S4001 after standby for a predetermined period.

As described above, the present invention realizes upgrading of an image outputting apparatus to a higher-speed, hence, higher resolution apparatus, economically, by providing an additional and detachable information processing unit that shares processing loads such as color conversion, resolution conversion, and rasterizing, and by providing a method, a computer program and a computer-readable storage medium thereof.

Further, the present invention is not limited to these embodiments, but various variations and modifications may be made without departing from the scope of the present invention.

The present application is based on

Japanese priority application No. 2001-094426 filed on Mar. 28, 2001, with the Japanese Patent Office, the entire contents of which are hereby incorporated by reference.

What is claimed is:

1. An image outputting apparatus, comprising:
a first information processing unit that carries out a first information processing,
a second information processing unit that carries out a second information processing, which is attachable to and detachable from the first information processing unit,
a detection unit that checks status of the second information processing unit, provided in the first information processing unit, and
an image outputting unit that outputs an image signal according to a predetermined output resolution based on an output of the detection unit.

2. The image outputting apparatus as claimed in claim 1, wherein the first information processing unit comprises a reporting unit that reports the status of the second information processing unit checked by the detection unit to a user.

3. The image outputting apparatus as claimed in claim 1, wherein the first processing unit comprises a direction unit that directs to use the second information processing unit when the second information processing unit functions normally, according to a result of the status checking by the detection unit.

4. The image outputting apparatus as claimed in claim 1, wherein the first information processing unit outputs a user permission signal that permits a user to obtain an output in a resolution higher than available from the first information processing unit, when the second information processing unit is used.

5. An image outputting apparatus, comprising:
a first information processing unit that carries out a first information processing,
a second information processing unit that carrier out a second information processing, which is attachable to and detachable from the first information processing unit,
a detection unit provided in the first information processing unit, which checks status of the second information processing unit,
an input interface that inputs a plurality of image data streams,
an image data inputting unit that inputs at least one of the image data streams,
an image data processing unit that processes the image data, which is formed into one body with the image data inputting unit, and
an image outputting unit that outputs an image in predetermined output resolution, based on a detection output and an image information output.

6. The image outputting apparatus as claimed in claim 5, wherein the first information processing unit and the second information processing unit perform the first processing and the second processing, respectively, according to a data transfer speed of the input interface.

7. The image outputting apparatus as claimed in claim 5, wherein a data processing speed of the image data processing unit is higher than a data transfer speed of the input interface.

8. The image outputting apparatus as claimed in claim 5, wherein the image data processing unit performs one or more of color conversion processing, image resolution conversion processing, and rasterizing.

9. The image outputting apparatus as claimed in claim 5, wherein the input interface is attachable to and detachable from the image data processing unit.

10. The image outputting apparatus as claimed in claim 5, further comprising a fault detection unit that checks whether there is a fault in the image data processing unit prior to a printing process execution, and directs not to use the image data processing unit if there is a fault.

11. The image outputting apparatus as claimed in claim 5, wherein the image data inputting unit and the image data processing unit that processes input image data are formed in one body, and the input interface, formed in the one body with the image data inputting unit and the image data processing unit that processes input image data, directly processes at least a part of the image data processed by the image data inputting unit.

12. The image outputting apparatus as claimed in claim 5, wherein a plurality of image data inputting units are provided and operate in parallel, each of the image data inputting units being combined with an image data processing unit.

13. The image outputting apparatus as claimed in claim 5, further comprising a compression and storing unit that compresses processed image data and stores the compressed image data.

14. An image outputting apparatus, comprising:
a first information processing unit that carries out a first information processing,
a second information processing unit that carries out a second information processing, that can be attached to and detached from the first information processing unit,
a detection unit that detects status of the second information processing unit, provided in the first information processing unit,
an image-processing execution unit, comprising a plurality of image data processing units, each of which is assigned a predetermined image processing task when outputting an image, and
an image outputting unit that outputs the image in a predetermined output resolution based on a detection output and an image-processing execution output.

15. The image outputting apparatus as claimed in claim 14, wherein the predetermined image processing task is defined by selecting one of an image object, a band, and a page.

16. The image outputting apparatus as claimed in claim 14, wherein the predetermined image processing task is defined by selecting at least one of color conversion, image resolution conversion, and rasterizing.

17. The image outputting apparatus as claimed in claim 14, wherein the plurality of image data processing units are provided in the image outputting unit such that each of the image information processing units carries out an assigned image processing task, thereby image processing is performed in parallel by the plurality of the image data processing units.

18. An image outputting method, comprising:
a first information processing step that carries out a first information processing,
a second information processing step that carries out a second information processing, which is attachable to and detachable from the first information processing step,
a detection step that detects status of the second information processing step, provided in the first information processing step, and
an image outputting step that outputs an image in predetermined output resolution based on a result of the detection step.

19. The image outputting method as claimed in claim 18, wherein the first information processing step further comprises:
an information step that informs a user of a result of the detection as for the status of the second information processing step detected by the first information processing step, and
a directing process that directs to use the second information processing step when the second information processing step performs normal operation.

20. The image outputting method as claimed in claim 18, wherein a user enabling signal is output from the first information processing step when the second information processing step is used, the user enabling signal indicating that higher output resolution than available from the first information processing step is available.

21. The image outputting method as claimed in claim 18, further comprising an image information processing step that performs at least one of color conversion, image resolution conversion, and rasterizing.

22. The image outputting method as claimed in claim 18, further comprising an image information processing step that further comprises a failure detection step that determines whether there is a failure in the image information processing step, prior to execution of a printing process, and directs not to use the image information processing step if there is a failure.

23. The image outputting method as claimed in claim 18, further comprising an image data inputting step that inputs image data, that further comprises an information storing step wherein processed image data are compressed and stored.

24. The image outputting method as claimed in claim 18, further comprising a plurality of image information processing steps, each of which is assigned to a predetermined selection of image processing tasks when outputting an image, and an image process execution step that performs image processing in parallel by the plurality of the image information processing steps.

25. The image outputting method as claimed in claim 18, wherein an image processing task is defined by a selecting at least one of an image object, a band, a page, color conversion, image resolution conversion, and rasterizing.

26. A computer program, comprising:
a first information processing step that carries out a first information processing,
a second information processing step that carries out a second information processing, that is attachable to and detachable from the first information processing step,
a detection step that detects status of the second information processing step, provided in the first information processing step, and
an image outputting step that outputs an image in predetermined output resolution based on a result of the detection.

27. The computer program as claimed in claim 26, further comprising:
an information step that informs a user the detection status of the second information processing step, provided in the first information processing step, and
a directing step that directs to use the second information processing step if the second information processing step performs normal operation.

28. The computer program as claimed in claim 26, wherein a user enabling signal is output from the first information processing step, whereby the user is allowed to use output resolution higher than the image output resolution available from the first information processing step, the user enabling signal being output from the first information processing step.

29. The computer program as claimed in claim 26, further comprising an image information processing step that is capable of selecting at least one of color conversion, image resolution conversion, and rasterizing tasks.

30. The computer program as claimed in claim 26, further comprising an image information processing step that comprises a failure detection step that determines whether there is a failure in the image information processing step, prior to execution of a printing process, and directs not to use the image information processing step when the failure is detected.

31. The computer program as claimed in claim 26, further comprising an image data inputting step that performs image data inputting, that further comprises an information storing step wherein processed image data are compressed and stored.

32. The computer program as claimed in claim 26, comprising a plurality of image information processing steps, each of which is dedicated to one of color conversion, image resolution conversion, and rasterizing tasks, and an image processing execution step that performs image processing in parallel by the plurality of the image information processing steps.

33. The computer program as claimed in claim 26, wherein image processing tasks comprise an image object, a band, a page, color conversion, image resolution conversion, and rasterizing.

34. A computer-readable storage medium that stores the computer program as claimed in claim 26.
